(19) United States
(12) Patent Application Publication
(10) Pub. No.: US 2026/0133720 A1
(43) Pub. Date: May 14, 2026

(54) STORAGE DEVICE AND METHOD FOR COMPLETION

(71) Applicant: Samsung Electronics Co., Ltd., Suwon-si (KR)

(72) Inventors: Jeongjae Cho, Suwon-si (KR); Jang Ryul Kim, Suwon-si (KR); In-Su Kim, Suwon-si (KR); Jinyong Park, Suwon-si (KR); Sangoak Woo, Suwon-si (KR)

(21) Appl. No.: 19/372,973

(22) Filed: Oct. 29, 2025

(30) Foreign Application Priority Data
Nov. 12, 2024 (KR) 10-2024-0160450

(51) Int. Cl. G06F 3/06

(52) U.S. Cl. CPC G06F 3/0659; G06F 3/0625; G06F 3/0679

(57) ABSTRACT

A storage device configured for connection to a host device includes a non-volatile memory and a storage controller configured to receive a write command for the non-volatile memory from the host device and to control programming of write data corresponding to the write command in the non-volatile memory. The storage controller may be configured to transmit a completion signal indicative of a completion of the write command to the host device based on at least one of program state information, indicating a program state of the write command, or device state information of the storage device.

### CROSS-REFERENCE TO RELATED APPLICATION(S)

This U.S. non-provisional application claims priority under 35 U.S.C. § 119 to Korean Patent Application No. 10-2024-0160450, filed on Nov. 12, 2024, in the Korean Intellectual Property Office, the disclosure of which is herein incorporated by reference in its entirety.

### BACKGROUND

Example embodiments relate generally to a storage device and a method for completion.

A storage device stores data under the control of a host device such as a computer, a smartphone, or a tablet. Most storage devices are powered by an external power supply. However, storage devices are susceptible to damage, including data loss, due to failures of external power supply or power-off such as sudden power-off (SPO).

To address the above power-related issues, storage devices may support power loss protection (PLP). PLP enables a storage device to back up (or dump) data stored in a buffer memory (or a cache memory) to a non-volatile memory in the event of power-off.

The storage device may perform command completion on a write command by buffering data in the buffer memory and then transmitting a completion for the write command to a host. The storage device should fully guarantee backup of data in the event of power-off occurring after performing the command completion. Accordingly, reducing the amount of backup by adjusting a completion time may be taken into consideration.

### SUMMARY

Example embodiments provide a storage device, capable of reducing the backup amount by setting a completion transmission time, and a method for completion.

According to an example embodiment, a storage device connected to a host device includes a non-volatile memory and a storage controller configured to receive a write command for the non-volatile memory from the host device and to control programming of write data corresponding to the write command in the non-volatile memory. The storage controller may be configured to transmit a completion for the write command to the host device based on at least one of program state information indicating a program state of the write command or device state information of the storage device.

According to an example embodiment, a method of a storage device connected to a host device includes receiving a write command from the host device, obtaining program state information indicating a program state of the write command and device state information of the storage device, and transmitting a completion for the write command to the host device based on at least one of the program state information or the device state information.

According to an example embodiment, a storage device connected to a host device includes a non-volatile memory, a storage controller configured to receive a write command for the non-volatile memory from the host device and to control programming of write data corresponding to the write command in the non-volatile memory, a buffer memory configured to buffer the write data, and a power loss protection (PLP) circuit configured to detect sudden power-off (SPO) from the storage device. The storage controller may be further configured to transmit a completion for the write command to the host device based on at least one of program state information indicating a program state of the write command or device state information of the storage device, and omit backing up of the buffered write data to the non-volatile memory when the SPO is detected before transmitting the completion to the host device.

### BRIEF DESCRIPTION OF DRAWINGS

The above and other aspects, features, and advantages of the present disclosure will be more clearly understood from the following detailed description, taken in conjunction with the accompanying drawings, wherein like reference numerals (when used) indicate corresponding elements throughout the several views, and in which:

FIG. 1 is a block diagram illustrating at least a portion of a storage system according to example embodiments;

FIG. 2 is a block diagram illustrating an example of the storage controller of FIG. 1, according to example embodiments;

FIG. 3 is a block diagram of a non-volatile memory of FIG. 1, according to example embodiments;

FIG. 4 is a circuit diagram illustrating an example of a memory block within a memory cell array of FIG. 3, according to example embodiments;

FIG. 5 is a diagram illustrating data states before and after a program operation and a re-program operation, according to example embodiments;

FIG. 6 is a timing diagram illustrating a backup operation in the event of sudden power-off (SPO);

FIG. 7 is a timing diagram illustrating an operation of setting a completion transmission time within a pre-program state, according to example embodiments;

FIG. 8 is a timing diagram illustrating an operation of setting a completion transmission time within a re-program state, according to example embodiments;

FIG. 9 is a timing diagram illustrating an operation of setting a completion transmission time, according to example embodiments;

FIG. 10 is a diagram illustrating a backup size based on the setting of a completion transmission time, according to example embodiments;

FIG. 11 is a flowchart illustrating a method of operating a storage device, according to example embodiments;

FIG. 12 is a flowchart illustrating a backup method of a storage device, according to example embodiments;

FIG. 13 is a flowchart illustrating a transmission timing setting method of a storage device, according to example embodiments;

FIG. 14 is a flowchart illustrating a program state verify method of a storage device, according to example embodiments;

FIG. 15 is a flowchart illustrating a method of operating a write command based on the program state verification of FIG. 14, according to example embodiments;

FIG. 16 is a flowchart illustrating a method of completing a command based on the program state verification of FIG. 14, according to example embodiments;

FIG. 17 is a flowchart illustrating a transmission timing setting method of a storage device, according to example embodiments; and

FIG. 18 is a block diagram of a storage device, according to example embodiments.

### DETAILED DESCRIPTION

Hereinafter, example embodiments will be described with reference to the accompanying drawings.

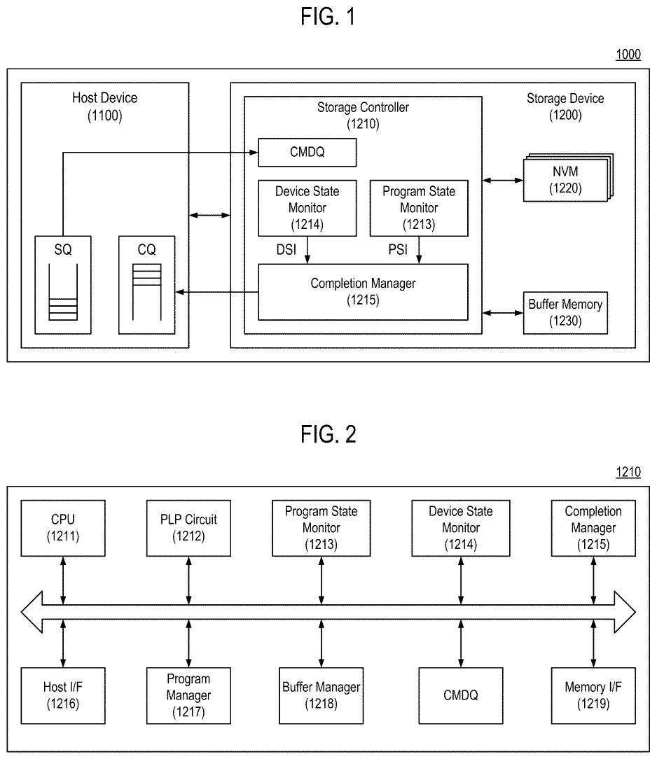

FIG. 1 is a block diagram illustrating a storage system according to example embodiments.

Referring to FIG. 1, a storage system 1000 according to example embodiments may include a host device 1100 and a storage device 1200. For example, the storage system 1000 may be a computing system configured to process various types of information, such as a personal computer (PC), a laptop computer, a server, a workstation, a tablet PC, a smartphone, or the like.

The host device 1100 may be configured to control the overall operation of the storage device 1200. The host device 1100 may generate commands, control the storage device 1200 based on the commands, or instruct the storage device 1200 to perform a required operation.

The host device 1100 may include a submission queue SQ and a completion queue CQ.

The submission queue SQ may be used by the host device 1100 to submit commands to be executed in the storage device 1200. For example, the submission queue SQ may be implemented as a circular buffer of a certain slot size. When there is a new command, the host device 1100 may update a tail doorbell, a register for managing the submission queue SQ. The storage device 1200 may recognize a new command through a tail pointer based on the update. The storage device 1200 may fetch submission queue entries from the submission queue SQ in order and execute commands based on the fetch.

The completion queue CQ may post the status of completed commands. For example, the completion queue CQ may be implemented as a circular buffer of a certain slot size. After completing the command, the storage device 1200 may find a position of the next empty completion queue entry through the completion queue tail pointer and create and post a completion entry. The host device 1100 may process the completion queue entry indicating an available completion queue (CQ) slot and then update the completion queue (CQ) head pointer. The host device 1100 may process the completion queue entry through the completion queue head pointer. When the position of the head pointer changes, the host device 1100 may notify the storage device 1200 of the new position through the head doorbell.

The storage device 1200 may include a storage controller 1210, a non-volatile memory (NVM) 1220, and a buffer memory 1230.

The storage controller 1210 may be configured to control the non-volatile memory 1220 and the buffer memory 1230 according to commands or control from the host device 1100. The storage controller 1210 may write data in the non-volatile memory 1220 or read data stored in the non-volatile memory 1220 based on the request of the host device 1100. For example, the storage controller 1210 may be configured to receive a write command for the non-volatile memory 1220 from the host device 1100 and control programming of write data corresponding to the write command in the non-volatile memory 1220.

The storage controller 1210 may schedule the processing order of commands received from the host device 1100. The storage controller 1210 may store commands based on the scheduling in a command queue CMDQ. The command queue CMDQ may temporarily store (for example, buffer) commands fetched from the host. For example, the command queue CMDQ may be implemented as a circular buffer of a certain slot size.

The non-volatile memory 1220 may store data or transfer stored data to the storage controller 1210 under the control of the storage controller 1210. For example, the non-volatile memory 1220 may be a NAND flash memory device, but example embodiments are not limited thereto.

In example embodiments, the non-volatile memory 1220 may be provided as a plurality of non-volatile memories 1220, and the plurality of non-volatile memories 1220 may be connected to the storage controller 1210 through a plurality of channels and a plurality of ways, respectively connected to the plurality of channels. The storage controller 1210 may access the plurality of non-volatile memories 1220 through the plurality of channels and the plurality of ways. In addition, the storage controller 1210 may perform processes on the plurality of non-volatile memories 1220 in parallel by generating and/or setting a stripe policy.

The buffer memory 1230 is a data buffer for data exchange between the storage device 1200 and the host device 1100 connected to the storage device 1200. Write data provided from the host device 1100 or data read from the non-volatile memory 1220 may be buffered (for example, temporarily stored) in the buffer memory 1230.

When a write request of the host device 1100 is made, the buffer memory 1230 may buffer write data to be stored (for example, programmed) in the non-volatile memory 1220. The term “buffering” refers to an operation in which the storage controller 1210 stores write data corresponding to a write command in the buffer memory 1230, and may also be regarded as an operation in which the storage controller 1210 registers a cache entry in the buffer memory 1230. Alternatively, when a read request of the host device 1100 is made and data present in the non-volatile memory 1220 is cached, the buffer memory 1230 may support a cache function of directly providing the cached data to the host device 1100.

For example, the buffer memory 1230 may be volatile memory such as a DRAM, an SRAM, or the like, and may be implemented as synchronous DRAM to provide sufficient buffering performance.

Hereinafter, examples of the storage controller 1210 will be described in more detail.

In example embodiments, the storage controller 1210 may manage or control a program operation on multi-bit cells included in each of the plurality of non-volatile memories 1220. For example, the multi-bit cells may include a multi-level cell (MLC), a triple-level cell (TLC), and/or a quad-level cell (QLC), and may include cells capable of storing more bits in a single cell than QLC. As used herein, the term “and/or” includes any and all combinations of one or more of the associated listed items.

In example embodiments, the storage controller 1210 may program write data, multi-bit data, in the non-volatile memory 1220 through a re-program scheme. The re-program scheme is a scheme to program the same data N times, where N is a positive integer. For example, N may be a predetermined value.

The storage controller 1210 may store data in the buffer memory 1230 before performing the re-programming scheme, and maintain the data stored in the buffer memory 1230 until the re-program scheme is completed (for example, N times of program operations are completed).

The re-program scheme may be performed through a pre-program operation and a re-program operation. The pre-program operation and/or the re-program operation may be performed one or more times. The total number of times the pre-program operation and the re-program operation are performed may be N, where N is a positive integer. The storage controller 1210 may pre-program write data in the plurality of non-volatile memories 1220. After the pre-program is completed, the storage controller 1210 may re-program the write data in the plurality of non-volatile memories 1220.

In example embodiments, when a power failure event such as SPO is detected during a program operation, the storage controller 1210 may back up the buffered write data to the non-volatile memory 1220.

In example embodiments, state group data (or digest data) indicating state information of the pre-programmed data may be generated during the pre-program operation (or after completion of the pre-program operation). The state group data may be generated during the pre-program operation or after completion of the pre-program operation.

When the state group data is generated, the storage controller 1210 according to example embodiment may back up (or dump) the state group data in the event that SPO occurs a period between the completion of the pre-program operation and the performance of the re-program operation. The storage controller 1210 may recover the write data based on the backed-up state group data, and perform the re-program operation based on the recovered data.

In example embodiments, the storage controller 1210 may be configured to dynamically set or adjust a transmission time of completion within a cycle of a write command to be processed based on the above-described re-program scheme. For example, the storage controller 1210 may fetch a command from the submission queue SQ included in the host device 1100 and transmit a completion signal indicative of the completion for the command to the host device 1100 to perform command completion for the command. A tail pointer of the completion queue CQ may move through the completion transmitted from the storage controller 1210. The storage controller 1210 may take various types of information into consideration to adjust the transmission time of the completion.

In example embodiments, the storage controller 1210 may include a program state monitor 1213, a device state monitor 1214, and a completion manager 1215.

The program state monitor 1213 may be configured to monitor a program state for a write command and obtain program state information PSI indicating a program state. The program state obtained by the program state monitor 1213 may be defined in various ways.

In example embodiments, the program state may indicate a single processing stage among a plurality of processing stages of the write command. The processing stages may correspond to unit operations performed by the storage device 1200 within a cycle of the write command to process the write command generated from the host device 1100.

For example, the processing stages corresponding to the unit operations may include at least one of a fetch stage of the write command, a buffering stage for the buffer memory 1230 of input data, a stage of transferring write data for a pre-program operation to the non-volatile memory 1220, a pre-program stage, a stage of transferring write data for a re-program operation to the non-volatile memory 1220, or a re-program stage. For example, the exemplary processing stages may correspond to unit operations performed by the storage device 1200 for a re-program operation of the write command.

In example embodiments, the program state may indicate a single processing sequence among a plurality of processing sequences, each of the plurality of processing sequences including one or more processing stages. For example, each processing sequence may include a plurality of processing stages, and the processing stages may correspond to the above-described unit operations. The processing sequences may be defined based on the size of backup required for each of the processing sequences. For example, some processing sequences may be set or defined to have the same backup size or different backup sizes.

In example embodiments, the program state may indicate the number of ways activated in each of the processing sequences of the write command. For example, the number of ways activated in each processing sequence may be set or defined based on a stripe policy.

The program state monitor 1213 may obtain program state information PSI indicating a program state according to the above-described embodiments and provide the program state information PSI to the completion manager 1215.

The device state monitor 1214 may be configured to monitor the storage device 1200 and obtain device state information DSI indicating setting and current state information of the storage device 1200. The device state information DSI obtained by the device state monitor 1214 may be defined in various ways.

In example embodiments, the device state information DSI may include at least one of a maximum queue depth of the command queue CMDQ, a queue depth of the command queue CMDQ for the write command at arbitrary time (for example, a current queue depth), or a size of the write command. The maximum queue depth may indicate the maximum number of commands that may be stored in the command queue CMDQ. The current queue depth may indicate the number of commands currently stored in the command queue CMDQ. The size of data transferred from the host device 1100 to the storage device 1200 may be defined based on the current queue depth and the size of the write command.

The device state monitor 1214 may obtain device state information DSI according to the above-described embodiments and provide the device state information DSI to the completion manager 1215.

The completion manager 1215 may be configured to transmit a completion signal, indicative of the completion of a command from the submission queue SQ, to the host device 1100 based on at least one of the program state information PSI provided from the program state monitor 1213 or the device state information DSI provided from the device state monitor 1214.

In example embodiments, the completion manager 1215 may dynamically set, determine, or adjust the transmission time of the completion of the command. The completion manager 1215 may set the optimal completion transmission time to reduce a backup size in the event of an SPO, considering processing intervals defined in relation to a program state, processing sequences, the number of ways activated in each interval or sequence, and/or device state information DSI.

Initially, the completion transmission time may be set to a time before the storage device 1200 begins a full-scale program operation after the write data corresponding to the write command has been buffered in the buffer memory 1230. When receiving a completion signal, the host device 1100 may trust that the storage device 1200 may guarantee at least the write data according to the write command. For example, the storage device 1200 should guarantee that the write data (for example, the data to be programmed) stored in the buffer memory 1230 is successfully backed up to the non-volatile memory 1220.

The completion manager 1215 may set the transmission time of the completion to an arbitrary processing sequence requiring backup when an SPO occurs after buffering, according to the embodiments described above. For example, the completion manager 1215 may set the processing sequence, requiring backup when SPO occurs after buffering, as the transmission time. The completion manager 1215 may transmit the completion in the program state corresponding to a last processing stage within the processing sequence set as the transmission time. Accordingly, even when an SPO occurs during the processing sequence requiring backup, the completion signal may be transmitted in a last program state, so that the storage device 1200 does not need to guarantee the data to be programmed. As a result, a backup size for the processing sequence may be reduced.

In example embodiments, the completion manager 1215 may set a processing stage following an arbitrary program stage (for example, a pre-program stage, a re-program stage) among the processing stages that may be included in the processing sequence, as the transmission time. For example, the completion manager 1215 may transmit a completion signal indicative of the completion of a command as soon as the program stage ends. Accordingly, even when an SPO occurs during the processing sequence, the completion signal may be transmitted after the data is programmed through at least the program stage, so that the storage device 1200 does not need to guarantee the data to be programmed. As a result, a backup size for the processing sequence may be reduced.

The transmission time may be dynamically set to significantly reduce backup size through the completion manager 1215, and the completion manager 1215 may transmit the completion to the host device 1100 according to the set transmission time. The completion manager 1215 may check whether the current time is the set transmission time for the completion, based on the program state information PSI and may transmit the completion signal when current time matches the transmission time.

In addition, when the processing sequence indicated by the program state matches the set transmission time, the completion manager 1215 does not need to guarantee the data. Therefore, the completion manager 1215 may omit the backup for that processing sequence.

The above-described storage system 1000 may reduce a backup size when SPO occurs, by setting the transmission time of the completion as an optimal time through the storage device 1200.

FIG. 2 is a block diagram illustrating an example of the storage controller 1210 of FIG. 1 according to example embodiments. Hereinafter, detailed descriptions of configurations overlapping those of FIG. 1 will be omitted.

Referring to FIG. 2, the storage controller 1210 according to example embodiments may include a central processing unit (CPU) 1211, a power loss protection (PLP) circuit 1212, a program state monitor 1213, a device state monitor 1214, a completion manager 1215, a host interface (I/F) 1216, a program manager 1217, a buffer manager 1218, and a memory interface 1219. Components within the storage controller 1210 may be connected through a system bus.

The CPU 1211 may include a processing unit such as a microprocessor. The CPU 1211 may control the overall operation of the storage controller 1210. The CPU 1211 may execute firmware for driving the storage controller 1210. For example, the CPU 1211 may execute various types of firmware loaded in a code memory, not explicitly illustrated (but implied).

In example embodiments, at least one of the program state monitor 1213, the device state monitor 1214, the completion manager 1215, or the program manager 1217 may be provided as a software module. The CPU 1211 may execute a software module corresponding to the program state monitor 1213, the device state monitor 1214, the completion manager 1215, and/or the program manager 1217 to perform the operations of the storage controller 1210 of the present application. Alternatively, the CPU 1211 may control at least one of the program state monitor 1213, the device state monitor 1214, the completion manager 1215, or the program manager 1217.

In example embodiments, the CPU 1211 may control the device state monitor 1214 to obtain device state information, control the program state monitor 1213 to obtain program state information, or control the completion manager 1215 to set the transmission time of the completion of a command. The CPU 1211 may perform a command completion based on the set transmission time.

In example embodiments, the CPU 1211 may include a plurality of cores. Each of the plurality of cores may be implemented as an individual processor core. The plurality of cores may include a host core, a flash translation layer (FTL) core, and a NAND core.

The host core may be defined as a core inside the storage device performing operations related to a host interface layer (HIL). For example, the host core may process a request input from the host through the host interface 1216. For example, the host core may manage commands, received from the host device (e.g., 1100 in FIG. 1), through the command queue CMDQ.

The FTL core may be defined as a core inside the storage device performing operations related to the FTL. For example, the FTL core may control the NAND core such that a read operation, a write operation, or an erase operation may be performed by the non-volatile memory based on the request received from the host core. Alternatively, the FTL core may perform an address mapping operation of mapping a logical block address (LBA) transmitted from the host to a physical block address (PBA), a physical location of the non-volatile memory, using the FTL.

The NAND core may be defined as a core inside the storage device performing operations related to the flash interface layer (FTL). For example, the NAND core may control the memory interface 1219 to perform operations on the non-volatile memory under the control of the FTL core. For example, the NAND core may control the memory interface 1219 based on a queue for controlling the non-volatile memory. A command for controlling the non-volatile memory may be queued through a queue.

The PLP circuit 1212 may monitor external power and detect power failure events such as SPO. When an SPO occurs, the PLP circuit 1212 may detect the SPO and may generate a detection signal based on the detection and provide the detection signal to the program manager 1217.

The program state monitor 1213 may obtain program state information and provides the program state information to the completion manager 1215, and the device state monitor 1214 may obtain device state information and provides the device state information to the completion manager 1215. The completion manager 1215 may set the transmission time of the completion of a command in consideration of the processing stages defined in relation to the program state, the processing sequences, the number of ways activated in each stage or sequence, and/or the device state information, and perform a command completion based on the set transmission time.

The host interface 1216 may provide an interface between the host device (1100 in FIG. 1) and the storage controller 1210. The host device and the storage controller 1210 may be connected through a single interface among various standardized interfaces. The standard interfaces may include various interface schemes such as an advanced technology attachment (ATA), a serial ATA (SATA), an external SATA (e-SATA), a small computer small (or system) interface (SCSI), a serial attached SCSI (SAS), a peripheral component interconnection (PCI), a PCI-express (PCIe), a universal serial bus (USB), IEEE 1394, a universal flash storage (UFS), or a card interface, although embodiments are not limited thereto.

The program manager 1217 may generate, set, and manage a program policy for a re-program operation. For example, the program policy may include the above-described stripe policy. When receiving a detection signal of SPO from the PLP circuit 1212, the program manager 1217 may suspend the program operation being performed. Then, the program manager 1217 may control the buffer manager 1218 to back up the data stored in the buffer memory to the non-volatile memory through the memory interface 1219.

In example embodiments, when SPO is detected during a pre-program operation or a re-program operation, the program manager 1217 may control the buffer manager 1218 to back up the write data to be pre-programmed or re-programmed to the non-volatile memory.

In example embodiments, when there is a waiting stage between a pre-program operation and a re-program operation and an SPO occurs in the waiting stage, the program manager 1217 may control the buffer manager 1218 to back up the state group data. In addition, the program manager 1217 may recover the write data based on the backed-up state group data and the pre-programmed data.

The buffer manager 1218 may control the read and write operations of the buffer memory. For example, the buffer manager 1218 may buffer write data or read data in the buffer memory under the control of the CPU 1211 or the program manager 1217. The buffer manager 1218 may buffer the write data, corresponding to the program operation at the time of SPO occurrence, in the buffer memory when an SPO occurs.

In example embodiments, when an SPO occurs during a pre-program operation, the buffer manager 1218 may buffer the write data to be pre-programmed in the buffer memory. In example embodiments, the buffer manager 1218 may buffer the state group data in the buffer memory when an SPO occurs after the pre-program operation is completed. In example embodiments, when an SPO occurs during a re-program operation, the buffer manager 1218 may back up write data to be re-programmed to the non-volatile memory.

In example embodiments, when the transmission time of the completion is set to a time after an arbitrary program stage (for example, a pre-program stage or a re-program stage) through the completion manager 1215, the buffer manager 1218 does not back up the write data to be programmed before the set transmission time. This is because the storage controller 1210 is not required to guarantee the write data to be programmed when the command completion has not yet been performed. Accordingly, a backup size for an SPO occurring before the transmission of the completion signal may be reduced.

The memory interface 1219 may provide interfacing between the storage controller 1210 and the non-volatile memory. For example, data processed by the CPU 1211 may be stored in the non-volatile memory through the memory interface 1219. For example, write data to be backed up may be backed up to the non-volatile memory through the memory interface 1219.

According to the above-described embodiments, the storage controller 1210 may set the transmission time of a completion to reduce a backup size when an SPO occurs before transmission of the completion signal.

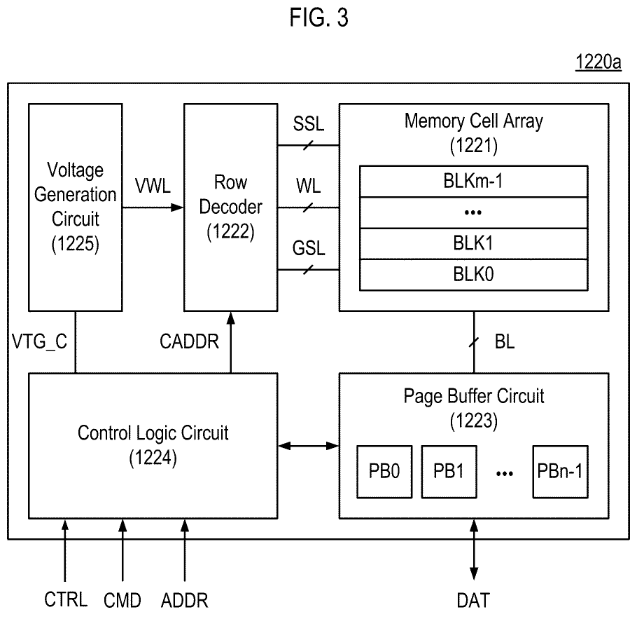

FIG. 3 is a block diagram of the non-volatile memory 1220 of FIG. 1, according to example embodiments.

Referring to FIG. 3, a non-volatile memory 1220a may include a memory cell array 1221, a row decoder 1222, a page buffer circuit 1223, a control logic circuit 1224, and a voltage generation circuit 1225. Although not explicitly illustrated in FIG. 3, the non-volatile memory 1220a may further include a data input/output circuit or an input/output interface, or the like. The non-volatile memory 1220a may further include components such as a column logic, a pre-decoder, a temperature sensor, a command decoder, or an address decoder. The non-volatile memory 1220a may be one of the plurality of non-volatile memories 1220 illustrated in FIG. 1.

The memory cell array 1221 may include a plurality of memory blocks BLK0 to BLKm-1, where m is a positive integer. Each of the plurality of memory blocks BLK0 to BLKm-1 may include a plurality of memory cells. The plurality of memory blocks BLK0 to BLKm-1 may be included in a single memory plane, but example embodiments are not limited thereto. The memory cell array 1221 may be connected to the page buffer circuit 1223 through bitlines BL, and may be connected to the row decoder 1222 through wordlines WL, string select lines SSL, and ground select lines GSL.

In example embodiments, the memory cell array 1221 may include a three-dimensional memory cell array 1221. The three-dimensional memory cell array may be configured with a plurality of levels, and may have wordlines or bitlines shared between the levels.

The row decoder 1222 may select one of the memory blocks of the memory cell array 1221 in response to a row address CADDR. The row decoder 1222 may select one of the wordlines of the selected memory block in response to the row address CADDR. The row decoder 1222 may transfer a voltage VWL, provided by the voltage generation circuit 1225, corresponding to an operation mode to a wordline of the selected memory block. The row decoder 1222 may transfer a program voltage and a verify voltage to the selected wordline and a pass voltage to an unselected wordline, during a program operation. The row decoder 1222 may transfer a read voltage to the selected wordline and a read pass voltage to the unselected wordline, during a read operation.

The page buffer circuit 1223 may include a plurality of page buffers PB0 to PBn-1, where n is a positive integer. The plurality of page buffers PB0 to PBn-1 may be connected to memory cells through a plurality of bitlines BL, respectively. The page buffer circuit 1223 may select at least one bitline, among the plurality of bitlines BLs, in response to a column address. The page buffer circuit 1223 may operate as a write driver or a sense amplifier depending on an operation mode. For example, the page buffer circuit 1223 may apply a bitline voltage corresponding to the data to be programmed to the selected bitline during a program operation. The page buffer circuit 1223 may sense a current or voltage of the selected bitline to sense the data stored in a memory cell during the read operation.

The control logic circuit 1224 may control the overall operation within the non-volatile memory 1220a. The control logic circuit 1224 may output various control signals for programming data to the memory cell array 1221, reading data from the memory cell array 1221, or erasing data stored in the memory cell array 1221 in response to a control signal CTRL, a command CMD, and/or an address ADDR. For example, the control logic circuit 1224 may output a voltage control signal VTG_C, an address CADDR, or the like.

In example embodiments, the control logic circuit 1224 may output control signals for programming multi-bit data based on the received control signal CTRL, command CMD, and/or address ADDR. For example, the control logic circuit 1224 may output control signals for a pre-program operation and a re-program operation, output control signals for backing up state group data, or output control signals for reading pre-programmed or re-programmed multi-bit data.

The voltage generation circuit 1225 may generate various types of voltages for performing program, read, and erase operations based on the voltage control signal VTG_C provided to the voltage generation circuit 1225. For example, the voltage generation circuit 1225 may generate a program voltage, a read voltage, and a program verify voltage as wordline voltages VWL. For example, the program voltage may be generated by an incremental step pulse program (ISPP) scheme.

In a program operation on multi-bit data, the voltage generation circuit 1225 may generate a pre-program verify voltage for a pre-program operation and a re-program verify voltage for a re-program operation. The pre-program verify voltage may be lower than the re-program verify voltage.

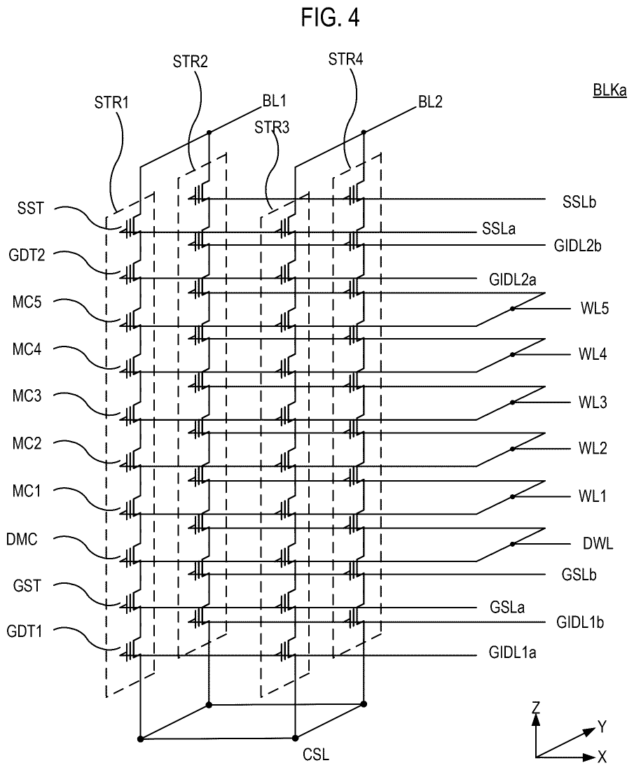

FIG. 4 is a circuit diagram illustrating an example of a memory block within a memory cell array 1221 of FIG. 3, according to example embodiments. For ease of description, an example is provided in which a single memory block includes four strings STR1 to STR4.

Referring to FIG. 4, a memory block BLKa may include a plurality of strings STR1 to STR4, vertically stacked (i.e., in a Z-axis direction) on a substrate. Each of the plurality of strings STR1 to STR4 may be disposed in a first direction (X-axis direction) and a second direction (Y-axis direction).

Strings located in the same column, among the plurality of strings STR1 to STR4, may be connected to the same bitline. For example, the first and second strings STR1 and STR2 may be connected to a first bitline BL1, and the third and fourth strings STR3 and STR4 may be connected to a second bitline BL2.

Each of the plurality of strings STR1 to STR4 may include a plurality of cell transistors. Each of the plurality of cell transistors may be a charge-trap flash (CTF) memory cell, but example embodiments are not limited thereto. The plurality of cell transistors may be stacked in a third direction (Z-axis direction).

The plurality of strings STR1 to STR4 may be commonly connected to a common source line CSL. For example, as illustrated in FIG. 4, a common source line CSL may be commonly connected to lower ends of the plurality of strings STR1 to STR4. However, this is only an example, and it is sufficient for the common source line CSL to be electrically connected to the lower ends of the strings STR1 to STR4, and it is not limited to being physically located at the lower ends of the strings STR1 to STR4. Hereinafter, for ease of description, the structure and configuration of a string will be described based on the first string STR1. The other strings STR2, STR3, and STR4 may have a similar structure to the first string STR1, and a detailed description thereof will be omitted.

The plurality of cell transistors may be connected in series between the first bitline BL1 and the common source line CSL. For example, the plurality of cell transistors may include gate-induced drain leakage (GIDL) transistors GDT1 and GDT2, a string select transistor SST, memory cells MC1 to MC5, a dummy memory cell DMC, and ground select transistors GST.

The first GIDL transistor GDT1 may be disposed at a lowermost end of the string STR1. For example, the first GIDL transistor GDT1 may be connected to the common source line CSL at a lower end of the string STR1. However, this is only an example, and example embodiments are not limited thereto. A gate of the first GIDL transistor GDT1 may be connected to a first GIDL line GIDL1a.

The second GIDL transistor GDT2 may be disposed at an upper end of the string STR1, but may be disposed between the string select transistor SST and the memory cell MC5. For example, the second GIDL transistor GDT2 may be connected to the first bitline BL1 through the string select transistor SST. A gate of the second GIDL transistor GDT2 may be connected to a second GIDL line GIDL2a.

In FIG. 4, the GIDL transistors GDT1 and GDT2 are illustrated as being provided at the lower and upper ends of the string STR1, respectively. However, this is only an example. In some embodiments, the GIDL transistor may be provided only at the upper end or only at the lower end of the string STR1.

A single string select transistor SST may be disposed at the uppermost end of a string STR. The string select transistor SST may be connected to the first bitline BL1 at the uppermost end of the string STR1. A gate of the string select transistor SST may be connected to a string select line SSLa. However, this is only an example. In some embodiments, a plurality of string select transistors connected in series may be provided between the first bitline BL1 and the second GIDL transistor GDT2.

A single ground select transistor GST may be provided between a dummy memory cell DMC and the first GIDL transistor GDT1. A gate of the ground select transistor GST may be connected to the ground select line GSLa. However, this is only an example. In some embodiments, a plurality of ground select transistors connected in series may be provided between the dummy memory cell DMC and the first GIDL transistor GDT1.

The first to fifth memory cells MC1 to MC5 may be connected in series between the string select transistor SST and the dummy memory cell DMC. Gates of each of the first to fifth memory cells MC1 to MC5 may be connected to the first to fifth wordlines WL1 to WL5.

A single dummy memory cell DMC may be provided between the first memory cell MC1 and the first GIDL transistor GDT1. A gate of the dummy memory cell DMC may be connected to a dummy wordline DWL. However, this is only an example. In some embodiments, a plurality of dummy memory cells connected in series may be provided between the first memory cell MC1 and the first GIDL transistor GDT1. Alternatively, an additional dummy memory cell may be provided between the string select transistor SST and the fifth memory cell MC5. Alternatively, an additional dummy memory cell may be provided between the memory cells MC1 to MC5. Alternatively, the dummy memory cell DMC may not be provided.

According to example embodiments, a program voltage may be applied to the gates of each of the first to fifth memory cells MC1 to MC5 through the first to fifth wordlines WL1 to WL5, and a pre-program operation or a re-program operation may be performed through the application of the program voltage.

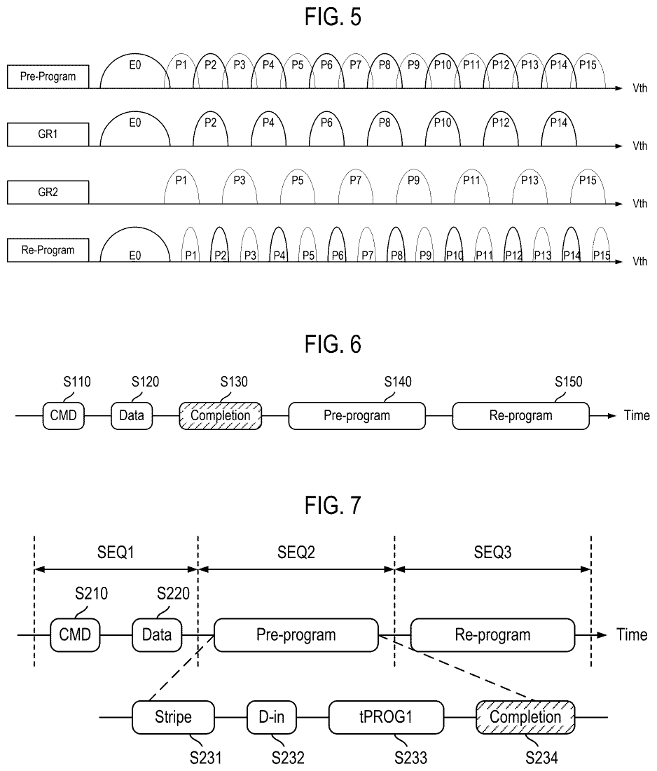

FIG. 5 is a diagram illustrating data states before and after a program operation and a re-program operation according to example embodiments.

Referring to FIG. 5, when a program operation starts, a storage device according to example embodiments may pre-program (or coarse-program) multi-bit data in memory cells of a non-volatile memory. For example, when the multi-bit data is 4-bit data (for example, when the memory cell is QLC), the pre-programmed memory cell may have a threshold voltage (Vth) corresponding to a single state among 16 threshold voltage states E0 and P1 to P15, as illustrated in the drawing. The 16 threshold voltage states E0 and P1 to P15 may correspond to the 16 values that the multi-bit data may have, respectively. For example, the pre-programmed memory cell may correspond to one of the 16 threshold voltage states E0 and P1 to P15 based on a multi-bit data value. The threshold voltages of the memory cells may fluctuate due to capacitive coupling between adjacent memory cells, leading to an increase in width of the threshold voltage distribution. Accordingly, adjacent threshold voltage distributions may overlap each other.

The threshold voltage distributions of the pre-programmed memory cells may be divided into a plurality of state groups. For example, threshold voltage states corresponding to the erase state E0 and the program states P1 to P15 may be divided into a first state group GR1 and a second state group GR2.

In example embodiments, each of the state groups may include different threshold voltage distributions, and the threshold voltage distributions of each of the state groups may not overlap each other. For example, the first state group GR1 may include threshold voltage distributions corresponding to the erase state E0, the second program state P2, the fourth program state P4, the sixth program state P6, the eighth program state P8, the tenth program state P10, the twelfth program state P12, and the fourteenth program state P14. The second state group GR2 may include threshold voltage states corresponding to the first program state P1, the third program state P3, the fifth program state P5, the seventh program state P7, the ninth program state P9, the eleventh program state P11, the thirteenth program state P13, and the fifteenth program state P15.

The number of state groups is only an example, and example embodiments are not limited thereto.

Each of the state groups may be represented by state group data.

For example, when the threshold voltage distributions are divided into four state groups, the state group data may be 2-bit data. For example, the number of bits of the state group data may be smaller than the number of bits of the multi-bit data.

The pre-programmed multi-bit data may correspond to state group data indicating one of the plurality of state groups according to the data value. For example, multi-bit data corresponding to the erase state E0 may correspond to state group data indicating the first state group, and multi-bit data corresponding to the first program state P1 may correspond to state group data indicating the second state group.

When an SPO occurs after pre-program operation is completed, the storage device may back up state group data corresponding to the pre-programmed memory cells in the non-volatile memory. For example, when multi-bit data corresponding to the first program state P1 is pre-programmed, the storage device may back up state group data indicating the second state group GR2 corresponding to the pre-programmed memory cell to the non-volatile memory.

When power is restored from the SPO, the storage device may recover the multi-bit data based on the backed-up state group data. For example, the storage device may read the multi-bit data from the pre-programmed memory cell based on the state group data. As illustrated in the drawing, even when there is an overlapping area in the threshold voltage distributions of the pre-programmed memory cells, a read operation performed on each state group based on the state group data may determine which threshold voltage distribution the overlapping area belongs to. Accordingly, the reliability of the recovered multi-bit data may be improved.

The storage device may re-program (or fine-program) the multi-bit data in the memory cell based on the recovered multi-bit data. The program operation on the multi-bit data may be completed by the re-program operation. As illustrated in the drawing, a width of the threshold voltage distribution of the memory cells may be decreased by performing the re-program operation.

The fluctuation range of a program voltage for a re-program operation may be lower than the fluctuation range of a program voltage for a pre-program operation. For example, the storage device may perform the re-program operation based on injecting a program voltage having a smaller fluctuation range.

Due to the difference in the fluctuation range of the program voltage, an increase in the threshold voltage of a memory cell caused by a re-program operation may be smaller than an increase in the threshold voltage of a memory cell caused by a pre-program operation. Therefore, the threshold voltage distribution based on the re-program operation may be less affected by coupling, resulting in narrower threshold voltage distributions for the memory cells and a reduced overlapping area according to the re-program operation. Accordingly, when multi-bit data is read from the re-programmed memory cell, the reliability of the multi-bit data may be improved.

In example embodiments, a re-program verify voltage for re-program operation multi-bit data may be higher than a pre-program verify voltage for pre-program operation multi-bit data. For example, the re-program verify voltage applied to any program state in the re-program operation may be higher than the pre-program verify voltage applied to any program state in the pre-program operation. For example, the pre-program operation may be performed using a pre-program verify voltage corresponding to a threshold voltage lower than a required threshold voltage. During the re-program operation, the memory cell may be programmed to the required threshold voltage using the re-program verify voltage higher than the pre-program verify voltage.

Although FIG. 5 illustrates threshold voltage states resulting from a single re-program operation, example embodiments are not limited thereto. For example, a re-program operation may be performed several times to generate a finer threshold voltage.

FIG. 6 is a timing diagram illustrating an example of a backup operation in the event of an SPO.

Referring to FIG. 6, in operation S110, the storage device may receive a write command from the host device. The storage device may fetch the write command from a submission queue and enqueue the write command in the command queue included in the storage device.

In operation S120, the storage device may receive and store write data corresponding to the write command from the host device. For example, the storage device may access a memory medium of the host device through direct memory access (DAM) and load the write data stored in the memory medium. The storage device may buffer the loaded write data in the buffer memory.

After the buffering of the write data is completed according to operation S120, the flow proceeds to operation S130 in which the storage device performs a command completion. The storage device may transmit the completion signal to the host device or write and post a completion entry in a completion queue. After operation S130, the storage device may guarantee the buffered write data.

The storage device may pre-program the write data in the non-volatile memory through operation S140, and may perform a re-program operation through operation S150. When SPO occurs in operation S140 or operation S150, the storage device should back up the write data to the non-volatile memory to guarantee the buffered write data.

FIG. 7 is a timing diagram illustrating an operation of setting a completion transmission time within a pre-program state according to example embodiments.

Referring first to FIG. 7, a program state may be defined as a processing stage or a processing sequence according to example embodiments. The processing sequence may be defined based on a backup size, and each processing stage included in the processing sequence may be defined based on a unit operation.

The storage device may receive a write command from the host device and buffer write data through operations S210 and S220. Unlike the illustration of FIG. 6, the storage device according to example embodiments may set the transmission time of a completion to a time after an arbitrary program stage is completed. The completion signal has not yet been transmitted in the first processing sequence SEQ1, backup is not required in the first processing sequence SEQ1 (for example, the backup size is 0). Operation S210 may be defined as a fetch stage of the write command, and operation S220 may be defined as a buffering stage of the write data.

The storage device may perform a pre-program operation through the second processing sequence SEQ2. In example embodiments, the second processing sequence SEQ2 may include operations S231 to S234.

In operation S231, the storage device may determine a stripe policy. In operation S232, the storage device may provide the write data to be pre-programmed to the non-volatile memory. In operation S233, the write data may be pre-programmed in the non-volatile memory. Operation S232 is a stage for transferring write data, and operation S233 may be defined as a pre-program stage. Operation S233 may be performed for a time tPROG1.

In operation S234, the storage device may transmit the completion signal indicative of the completion of a command to the host device. For example, the transmission time of the completion of the command according to example embodiments may be included in a second processing sequence SEQ2, and may be a time after operation S233 is completed. When the completion signal is transmitted in the first processing sequence SEQ1, when an SPO occurs in the second processing sequence SEQ2 including the pre-program stage, backup for the entire buffered write data is required in the event of an SPO occurring in the second processing sequence SEQ2 (for example, a backup size for the second processing sequence SEQ2 is a buffered data size).

The transmission time of the completion is set to operation S234 according to example embodiments, so that the storage device does not need to back up the write data even when an SPO occurs in the second processing sequence SEQ2. For example, the backup size is 0.

In example embodiments, in operation S234, the storage device may check whether a current program state (for example, a program state after the pre-program stage is completed or in the second processing sequence SEQ2) matches the set transmission time, based on the program state information. When the current program state matches the set transmission time, the storage device may transmit the completion signal to the host device.

Then, the storage device may perform a re-program operation through a third processing sequence SEQ3.

The storage device according to the above-described embodiments may reduce the backup size when an SPO occurs by setting the transmission time of the completion of a command to the second processing sequence SEQ2 (for example, a processing sequence in which backup for the entire buffered data is required in an example in which the processing sequence is performed after transmitting the completion signal). In addition, latency caused by completion delay may be reduced compared to the case in which the completion signal is transmitted after the second processing sequence SEQ2.

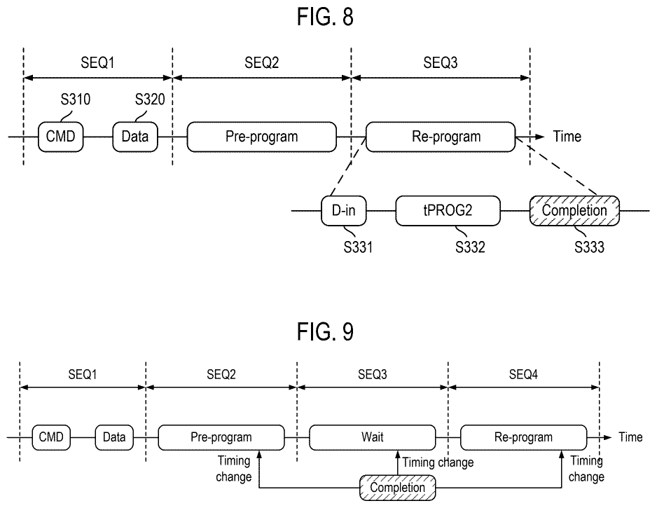

FIG. 8 is a timing diagram illustrating an operation of setting a completion transmission time within a re-program state according to example embodiments. Hereinafter, detailed descriptions of configurations overlapping those of FIG. 7 will be omitted.

Referring to FIG. 8, the storage device may receive a write command from the host device and buffer write data through operations S310 and S320. Unlike the illustration of FIG. 7, the storage device according to example embodiments may set the transmission time of a completion to a third processing sequence SEQ3.

The storage device may perform a pre-program operation through the second processing sequence SEQ2, and perform a re-program operation through the third processing sequence SEQ3 after the pre-program operation is completed. In example embodiments, the third processing sequence SEQ3 may include operations S331 to S333.

In operation S331, the storage device may provide write data to be re-programmed to the non-volatile memory. In operation S332, the write data may be re-programmed in the non-volatile memory. Operation S331 is a stage in which write data is transferred, and operation S332 may be defined as a re-program stage. Operation S332 may be performed for a time tPROG2.

In operation S333, the storage device may transmit a completion signal indicative of the completion of a command to the host device. For example, the transmission time of the completion of the command according to example embodiments is included in the third processing sequence SEQ3, and is a time after operation S332 is completed. When the completion signal is transmitted in the first processing sequence SEQ1 or the second processing sequence SEQ2, backup for the entire buffered write data is required in the event of an SPO occurring in the third processing sequence SEQ3 including the re-program stage.

The transmission time of the completion is set to operation S333 according to example embodiments, so that the storage device does not need to back up the write data even when SPO occurs in the third processing sequence SEQ3. For example, a backup size is 0.

In example embodiments, in operation S333, the storage device may check whether a current program state (for example, a program state after the re-program stage is completed or in the third processing sequence SEQ3) matches the set transmission time, through the program state information. When the current program state matches the set transmission time, the storage device may transmit the completion signal to the host device.

The storage device according to the above-described embodiments may reduce the backup size when an SPO occurs by setting the transmission time of the completion of a command to the third processing sequence SEQ3 (for example, a processing sequence in which backup for the entire buffered data is required in an example in which the processing sequence is performed after transmitting the completion signal). In addition, latency caused by completion delay may be reduced compared to the case in which the completion signal is transmitted after the third processing sequence SEQ3.

FIG. 9 is a timing diagram illustrating an operation of setting a completion transmission time according to example embodiments.

Referring to FIG. 9, the storage device may process a write command through first to fourth processing sequences SEQ1 to SEQ4. According to example embodiments, the storage device may have a waiting stage (the third processing sequence SEQ3) before the fourth processing sequence SEQ4. When an SPO occurs in the third processing sequence SEQ3, the storage device may back up state group data and recover the write data based on the backed-up state group data and the pre-programmed data through the second processing sequence SEQ2.

In example embodiments, the storage device may set the transmission time of a completion to one of the second to fourth processing sequences SEQ2 to SEQ4. Sizes of the buffer memory (for example, sizes of data stored in the buffer memory) in the processing sequences may be the same or different. The size of the buffer memory may correspond to a backup size. According to example embodiments, when backup based on state group data is performed in the third processing sequence SEQ3, the backup size in the third processing sequence SEQ3 may be smaller than the size of the buffer memory.

The storage device may set one of the processing sequences SEQ2 to SEQ4, in which the backup size is the same as the size of the buffer memory, as the transmission time of the completion. When the program state matches the set transmission time (for example, a corresponding processing sequence), the storage device may transmit the completion signal to the host device. For example, the storage device may transmit the completion signal in the program state corresponding to a last processing stage in the corresponding processing sequence.

In addition, when the corresponding processing sequence and the transmission time match, the storage device may omit the backup for the SPO occurring in the corresponding processing sequence. Accordingly, the backup size may be reduced when SPO occurs.

The operation of the storage device according to FIGS. 6 to 9 described above may be performed based on the storage controller, the non-volatile memory, and/or the buffer memory according to the above-described embodiments.

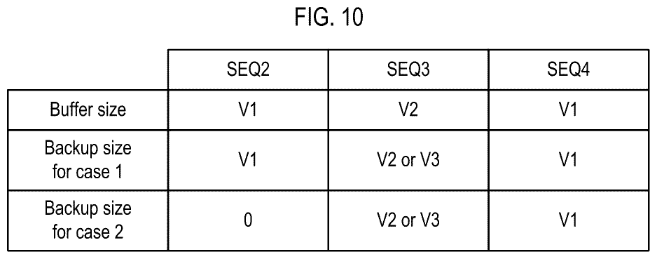

FIG. 10 is a diagram illustrating a backup size based on the setting of a completion transmission time according to example embodiments.

Referring to FIG. 10, a buffer size for each of the second to fourth processing sequences SEQ2 to SEQ4, a backup size for Case 1, and a backup size for Case 2 are compared and illustrated. Case 1 is a case in which a command completion is completed in the first processing sequence SEQ1, and Case 2 is a case in which a command completion is completed in the second processing sequence SEQ2. The buffer size is a size of a buffer memory.

For both Case 1 and Case 2, a pre-program operation of FIGS. 5 to 9 is performed in the second processing sequence SEQ2, and a re-program operation of FIGS. 5 to 9 is performed in the fourth processing sequence SEQ4. The third processing sequence SEQ3 is a stage performed between the pre-program operation and the re-program operation. In the third processing sequence SEQ3, recovery based on state group data for dividing program states into state groups (for example, GR1, GR2 in FIG. 5) may be performed.

Regardless of a program voltage or a verify voltage, a buffer size required in the second processing sequence SEQ2 and the fourth processing sequence SEQ4 may be set depending on the number of channels, ways, planes, the size of pages, or the like, based on the stripe policy. For example, each processing sequence buffers and programs the same multi-bit data, so that a buffer size required in each processing sequence is the same as V1.

In the case of the third processing sequence SEQ3, V2 that is the same as or different from V1 may be defined as a buffer size according to example embodiments. V2 may be a buffer size required in a waiting stage after the pre-program operation and before the re-program operation.

According to Case 1, when SPO occurs in each processing sequence, a backup size is a buffer size. For example, the backup size of the second processing sequence SEQ2 and the fourth processing sequence SEQ4 is V1 that is the same as the buffer size. In the case of the third processing sequence SEQ3, when the above-described state group data is used, the backup may not need to be performed for all buffer sizes. The backup size may be V3 that is smaller than the buffer size V2. When the state group data is not used, the backup size may be V2 that is the same as the buffer size.

According to Case 2, the program stage to be performed in the second processing sequence SEQ2 is a stage before the completion signal is transmitted. Therefore, the guarantee of the data to be backed up is not required. As a result, the backup size for the second processing sequence SEQ2 is 0.

Unlike the above embodiment, the completion signal may be transmitted in the third processing sequence SEQ3. Even when SPO occurs in the processing sequence and a previous processing sequence, the backup size may be 0. As a result, the backup size may be reduced by setting an optimal completion transmission time.

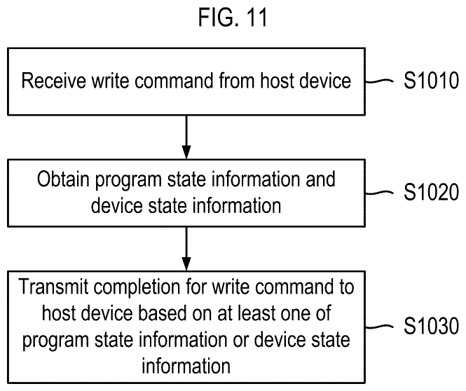

FIG. 11 is a flowchart illustrating a method of operating a storage device according to example embodiments.

Referring to FIG. 11, in operation S1010, the storage device may receive a write command from a host device. The storage device may fetch the write command from a submission queue included in the host device. The storage device may manage the received write command through a command queue.

In operation S1020, the storage device may obtain program state information indicating the program state for the write command and device state information for the storage device. In example embodiments, operation S1020 may be repeatedly performed periodically or aperiodically. In example embodiments, operation S1020 may be performed whenever there is a change in the information that may be included in program state information and/or device state information.

In operation S1030, the storage device may transmit a completion signal for completion of the write command to the host device based on at least one of the program state information or the device state information. In example embodiments, the storage device may set a transmission time of the completion of the command to reduce a backup size in consideration of information related to the program state (for example, a processing stage, a processing sequence, or the like) and device state information. The storage device may check whether current time matches the transmission time, based on the program state information. When the current time matches the transmission time, the storage device may transmit the completion signal.

According to the above-described embodiments, an optimal completion transmission time may be set through the method of operating the storage device to reduce a backup size when an SPO occurs.

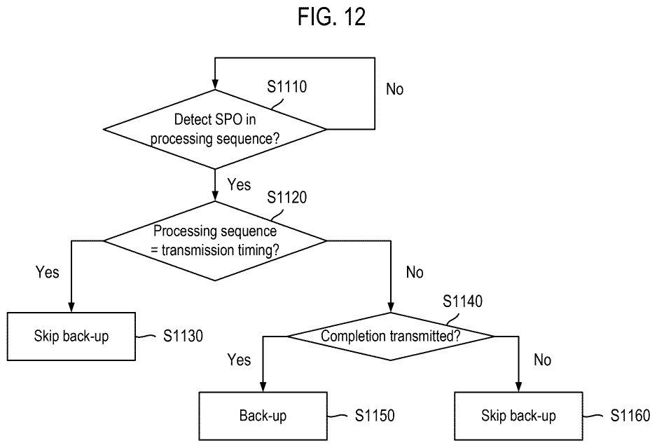

FIG. 12 is a flowchart illustrating a backup method of a storage device according to example embodiments.

Referring to FIG. 12, in operation S1110, the storage device may detect an SPO for the storage device. For example, the storage device may detect an SPO by monitoring external power. When an SPO is not detected, an SPO detection operation in operation S1110 may be repeatedly performed.

When an SPO is detected during an arbitrary processing sequence through operation S1110, the flow proceeds to operation S1120 in which the storage device checks whether a processing sequence, in which the SPO is detected, matches a transmission time set for the completion of a command.

When the processing sequence matches the transmission time in operation S1120, the flow proceeds to operation S1130 in which the storage device omits backup for the processing sequence. For example, a command completion may be completed in the processing sequence, so that data guarantee for the processing sequence is not required. Accordingly, the storage device may omit the backup.

When the processing sequence does not match the transmission time in operation S1120, the flow proceeds to operation S1140 in which the storage device checks whether the completion signal has been transmitted. When the completion signal has already been transmitted, for example, when the completion signal has been transmitted in a processing sequence before the processing sequence in which the SPO is detected (“Yes” in operation S1140), the flow proceeds to operation S1150 in which the storage device performs backup for the SPO.

When the completion signal has not yet been transmitted (“No” in operation S1140), the flow proceeds to operation S1160 in which the storage device may omit the backup.

According to the above-described backup method, backup may be omitted when the completion signal is not transmitted. As a result, a backup size may be reduced when SPO is detected.

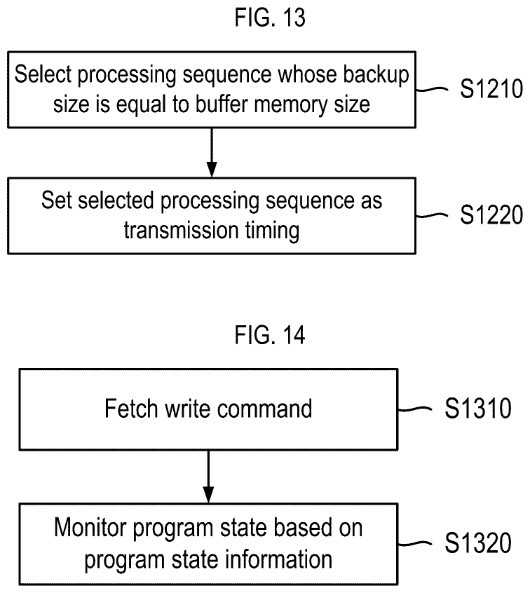

FIG. 13 is a flowchart illustrating a transmission timing setting method of a storage device according to example embodiments.

Referring to FIG. 13, in operation S1210, the storage device may select a single processing sequence in which a backup size is the same as a buffer memory size, among processing sequences each including processing stages of a write command. For example, a processing sequence in which backup for the entire write data stored in a buffer memory is required may be selected through operation S1210.

In operation S1220, the storage device may set the selected single processing sequence as the transmission time of a completion of a command. Then, the storage device may transmit the completion signal in the processing sequence.

FIG. 14 is a flowchart illustrating a program state verify method of a storage device according to example embodiments.

Referring to FIG. 14, in operation S1310, the storage device may fetch a write command from a submission queue of a host device. In operation S1320, the storage device may monitor a program state for the fetched write command based on program state information. The program state information may indicate one of processing stages and processing sequences for the above-described write command operation. The monitoring enables the storage device to check a current program state.

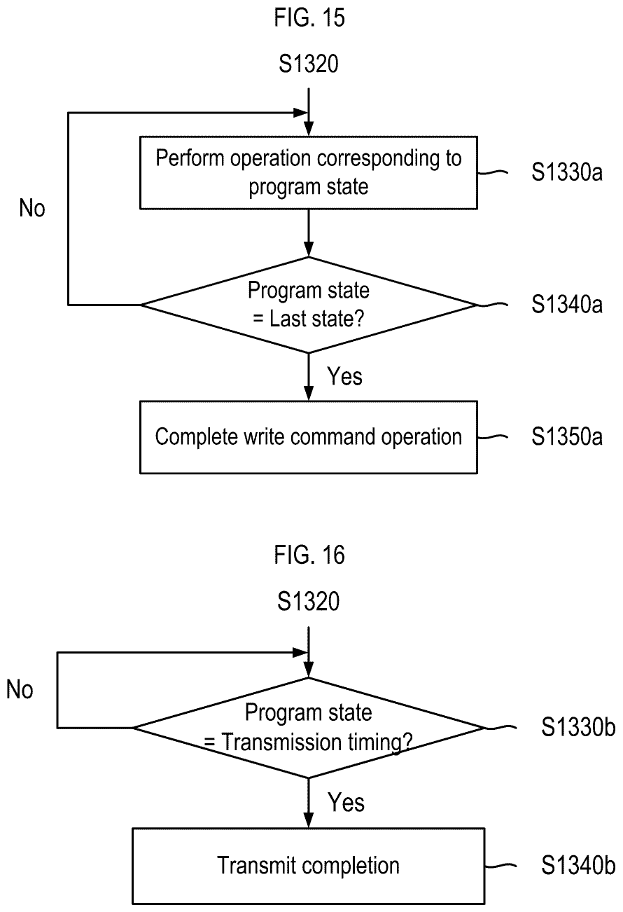

FIG. 15 is a flowchart illustrating a method of operating a write command based on the program state verification of FIG. 14, according to example embodiments.

Referring to FIG. 15, in operation S1330a, the storage device may perform an operation corresponding to the current program state checked in operation S1320 of FIG. 14. For example, the operation may correspond to one of the above-described processing stages or processing sequences.

In operation S1340a, the storage device checks whether a current program state is a last state. The last state may correspond to a last processing stage within the above-described processing sequence or a last processing sequence among processing sequences for a write command.

When the program state is the last state, the flow proceeds to operation S1350a in which the storage device may complete a write command operation. When the program state is not the last state, the storage device may repeat operations S1330a to S1340a.

FIG. 16 is a flowchart illustrating a method of completing a command based on the program state verification of FIG. 14, according to example embodiments.

Referring to FIG. 16, in operation S1330b, the storage device may check whether the current program state checked in operation S1320 of FIG. 14 matches a transmission time set for a completion.

When the current program state matches the transmission time, the flow proceeds to operation S1340b in which the storage device may transmit the completion signal to the host device. For example, operation S1340b may be performed only when the program state matches the transmission time. When the program state does not match the transmission time, the storage device may repeat operation S1330b.

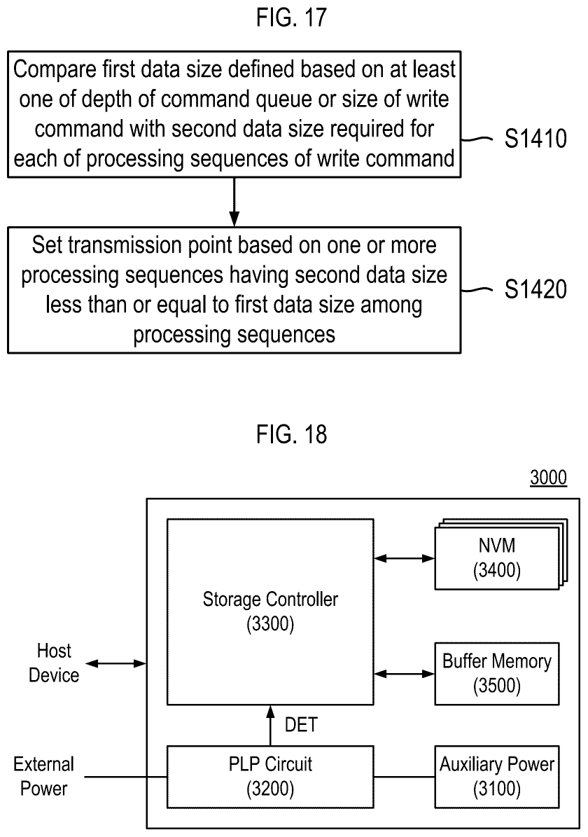

FIG. 17 is a flowchart illustrating a transmission timing setting method of a storage device according to example embodiments.

Referring to FIG. 17, in operation S1410, the storage device may compare a first data size and a second data size. The first data size is defined based on at least one of a depth of command queue or a size of write command, and may refer to a size of data transferred from the host device to the storage device. The second data size may be required for each of the processing sequences of the write command. For example, the second data size may be a minimum data size required to process the processing sequence.

Through operation S1410, the storage device may compare a size of data transferred in each processing sequence and a size of data required for processing each processing sequence.

In operation S1420, the storage device may set a transmission time based on one or more processing sequences having a second data size less than or equal to the first data size, among the processing sequences. For example, among the processing sequences, only processing sequences having a sufficient size of data transferred from the host device may be considered as transmission time setting targets.

When the first data size is smaller than the second data, the program operation based on the processing sequence may result in waste equivalent to a size of data that falls short of the processing capacity of the processing sequence. The storage device may reduce such waste through the setting method according to the above-described embodiments. In addition, the storage device may dynamically set the transmission time based on the device state information.

FIG. 18 is a block diagram of a storage device 3000, according to example embodiments.

Referring to FIG. 18, the storage device 3000 according to example embodiments may include an auxiliary power supply 3100, a PLP circuit 3200, a storage controller 3300, a plurality of non-volatile memories 3400, and a buffer memory 3500.

The auxiliary power supply 3100 may supply accumulated energy to the storage device 3000 in the event of an SPO in which external power is cut off. The storage device 3000 may complete an operation being performed and perform a data backup operation using energy from the auxiliary power supply 3100. The more backup amount, the more energy accumulation may be required in the auxiliary power supply 3100.

The PLP circuit 3200 may be configured to prevent loss of power supplied to the storage device 3000. The PLP circuit 3200 may be implemented as an integrated circuit (IC), a chip, or an element. In a situation in which external power is normally supplied, the PLP circuit 3200 may supply the external power as power used by the storage device 3000. When the external power is cut off, the PLP circuit 3200 may provide an output of the auxiliary power supply 3100 as power used by the storage device 3000.

The PLP circuit 3200 may detect an SPO event such as a cutoff of external power or a severe voltage drop. When the SPO event is detected, the PLP circuit 3200 may provide a power-off detection signal DET to the storage controller 3300. In addition, the PLP circuit 3200 may switch a source of power for driving the storage device 3000 from external power to the auxiliary power supply 3100.

The storage controller 3300 may be configured to control the plurality of non-volatile memories 3400 and the buffer memory 3500 according to commands or controls from a host. For example, the storage controller 3300 may write data in the plurality of non-volatile memories 3400 or read data stored in the plurality of non-volatile memories 3400, in response to a request from the host. The storage controller 3300 may provide commands, addresses, data and control signals to the plurality of non-volatile memories 3400 to access the plurality of non-volatile memories 3400.

The storage controller 3300 may set the transmission time of the completion according to the above-descried embodiments and transmit the completion signal to the host device based on the set transmission time. In example embodiments, when SPO is detected from the PLP circuit 3200 before transmitting the completion signal to the host device based on the set transmission time, the storage controller 3300 may omit backup of the buffered write data to the non-volatile memory 3400.

The plurality of non-volatile memories 3400 and the buffer memory 3500 are substantially the same as those in FIG. 1 described above, and detailed descriptions thereof are omitted.

The storage device 3000 according to the above-described embodiments may set a completion at a transmission time, at which a backup size may be reduced, to reduce the backup size and dependency of the capacity of the PLP circuit.

As set forth above, according to example embodiment, a storage device, capable of reducing the backup amount by setting a completion transmission time, and a method for completion may be provided.

Aspects of the present invention are described herein with reference to flowchart illustrations and/or block diagrams of methods, and apparatus (systems) according to embodiments of the inventive concept. It will be understood that the flowcharts and/or block diagrams in the accompanying figures illustrate the architecture, functionality, and/or operation of possible implementations of systems and methods according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or act or carry out combinations of special purpose hardware and computer instructions.

While example embodiments have been shown and described above, it will be apparent to those skilled in the art that modifications and variations could be made without departing from the scope of the present inventive concept as defined by the appended claims.

What is claimed is:

1. A storage device configured for connection to a host device, the storage device comprising:
a non-volatile memory; and
a storage controller configured to receive a write command for the non-volatile memory from the host device and to control programming of write data corresponding to the write command in the non-volatile memory,
wherein:
the storage controller is configured to transmit a completion signal indicative of a completion of the write command to the host device based on at least one of program state information indicating a program state of the write command or device state information of the storage device.

2. The storage device of claim 1, wherein:
the program state indicates a single processing stage among a plurality of processing stages of the write command.

3. The storage device of claim 2, wherein:
the plurality of processing stages comprises at least one of a fetch stage of the write command, a buffering stage of the write data, a stage for transferring the write data for a pre-program operation to the non-volatile memory, a pre-program stage, a stage for transferring the write data for a re-program operation to the non-volatile memory, or a re-program stage.

4. The storage device of claim 1, further comprising:
a buffer memory configured to buffer the write data,
wherein:
the storage controller is configured to back up the buffered write data to the non-volatile memory when a sudden power-off (SPO) is detected from the storage device.

5. The storage device of claim 4, wherein:
the program state indicates a single processing sequence among a plurality of processing sequences, each of the plurality of processing sequences comprising processing stages of the write command, and
the plurality of processing sequences are defined based on a backup size required for each of the plurality of processing sequences.

6. The storage device of claim 5, wherein:
the storage controller is configured to set a single processing sequence, among the plurality of processing sequences, having the backup size equal to a size of the buffer memory as a transmission time of the completion of the write command.

7. The storage device of claim 1, wherein:
the storage controller is configured to transmit the completion signal to the host device when the program state matches a transmission timing set for the completion of the write command.

8. The storage device of claim 5, wherein:
the storage controller is configured to omit a backup for the single processing sequence when the single processing sequence matches a transmission timing set for the completion of the write command.

9. The storage device of claim 1, wherein:
the device state information comprises at least one of a queue depth of a command queue for the write command at an arbitrary time or a size of the write command.

10. The storage device of claim 9, wherein:
the storage controller is configured:
to compare a first data size, defined based on at least one of the queue depth of the command queue or the size of the write command, with a second data size required for each of a plurality of processing sequences of the write command; and
to set a transmission time of the completion of the write command based on one or more processing sequences having the second data size less than or equal to the first data size, among the plurality of processing sequences.

11. The storage device of claim 1, wherein:
the program state indicates a number of ways activated in each processing sequence of the write command.

12. A method of operating a storage controller of a storage device comprising a non-volatile memory and configured for connection to a host device, the method comprising:
receiving a write command from the host device;
obtaining program state information, indicating a program state of the write command, and device state information of the storage device; and
transmitting a completion signal indicative of a completion of the write command to the host device based on at least one of the program state information or the device state information.

13. The method of claim 12, wherein:
the program state indicates a single processing stage among a plurality of processing stages of the write command, and
each of the plurality of processing stages comprises at least one of a fetch stage of the write command, a buffering stage of write data, a stage for transferring the write data for a pre-program operation to the non-volatile memory, a pre-program stage, a stage for transferring the write data for a re-program operation to the non-volatile memory, or a re-program stage.

14. The method of claim 12, further comprising:
selecting a single processing sequence having a backup size equal to a size of a buffer memory, from among processing sequences comprising a plurality of processing stages of the write command; and
setting the selected single processing sequence as a transmission time for the completion of the write command.

15. The method of claim 12, further comprising:
checking whether the program state matches a transmission time set for the completion of the write command,
wherein:
the transmitting of the completion signal to the host device is performed when the program state matches the transmission time.

16. The method of claim 15, further comprising:
omitting backup for a single processing sequence indicated by the program state when the single processing sequence matches the transmission time.

17. The method of claim 12, wherein:
the device state information comprises at least one of a queue depth of a command queue for the write command at an arbitrary time or a size of the write command.

18. The method of claim 17, further comprising:
comparing a first data size, defined based on at least one of the queue depth of the command queue or the size of the write command, with a second data size required for each of a plurality of processing sequences of the write command; and
setting a transmission time of the completion of the write command based on one or more processing sequences having the second data size less than or equal to the first data size, among the plurality of processing sequences.

19. A storage device configured for connection to a host device, the storage device comprising:
a non-volatile memory;
a storage controller configured to receive a write command for the non-volatile memory from the host device and to control programming of write data corresponding to the write command in the non-volatile memory;
a buffer memory configured to buffer the write data; and
a power loss protection (PLP) circuit configured to detect a sudden power-off (SPO) from the storage device,
wherein the storage controller is configured:
to transmit a completion signal indicative of a completion of the write command to the host device based on at least one of program state information, indicating a program state of the write command, or device state information of the storage device; and
to omit backing up of the buffered write data to the non-volatile memory when the SPO is detected before transmitting the completion signal to the host device.

20. The storage device of claim 19, wherein:
the storage controller is configured to transmit the completion signal to the host device when the program state matches a transmission time set for the completion of the write command.
